(19) United States
(12) Patent Application Publication
(10) Pub. No.: US 2016/0309545 A1
(43) Pub. Date: Oct. 20, 2016

(54) Portable Heated Storage Box for Tubular Containers

(71) Applicant: Chad Burroughs, St. Paris, OH (US)

(72) Inventor: Chad Burroughs, St. Paris, OH (US)

(21) Appl. No.: 14/840,112

(22) Filed: Aug. 31, 2015

Related U.S. Application Data
(60) Provisional application No. 62/055,718, filed on Sep. 26, 2014.

(51) Int. Cl. H05B 3/00; A45C 11/00; A45C 13/02; H05B 3/18

(52) U.S. Cl. CPC H05B 3/008; H05B 3/18; A45C 11/00; A45C 13/02; A45C 2013/026

(57) ABSTRACT

A portable heated storage box is configured to hold tubular grooming spray containers. The storage box has a hinged top for access to the stored spray containers, and houses a waterproof electric heating element, a metal screen disposed above the heating element for supporting the containers while allowing the heating element to heat the containers by radiation and convection, a tray disposed above the screen for laterally retaining and spacing the containers, and a thermostat that regulates the operation of the heating element to maintain the air temperature in the box within a prescribed range.

### RELATED APPLICATIONS

This application claims priority based on the Provisional Patent Application No. 62/055,718, filed Sep. 26, 2014.

### TECHNICAL FIELD

The present invention relates to a portable heated storage box configured to hold tubular grooming spray containers, and to maintain them at a desired temperature for best performance in cold ambient environments.

### BACKGROUND OF THE INVENTION

When an animal such as a horse or steer is being cleaned and groomed in preparation for the show ring at a competition or sale event, meticulous care is taken by the groomers to ensure that the animal's appearance is the best that it can be. Various grooming products are applied to the animal's coat, and nails or hooves, and many of the products are applied as a tubular spray container, whether aerosol or non-aerosol.

For best performance, grooming product spray containers have to be stored and maintained within a nominal temperature range, such 65-80 degrees F. This, of course, poses a problem for the groomer when working in an unheated area during the cold weather months. A groomer typically must either keep the spray containers in a heated vehicle, or use a portable heater to train a hot airflow on them. Not surprisingly, these techniques are often impractical and provide less than optimal results.

While various heated storage boxes have been developed for food warming, construction equipment, and so forth, none are particularly well suited to storing grooming spray containers and allowing ease of use by the groomer. Accordingly, what is needed is a portable heated storage box configured to hold grooming spray containers.

### SUMMARY OF THE INVENTION

The present invention is directed to an improved portable heated storage box apparatus configured to hold grooming spray containers. The storage box has a hinged top for access to the stored spray containers, and houses a waterproof electric heating element, a metal screen disposed above the heating element for supporting the containers while allowing the heating element to heat the containers by radiation and convection, a tray disposed above the screen for laterally retaining and spacing the containers, and a thermostat that regulates the operation of the heating element to maintain the air temperature in the storage box within a prescribed range.

### BRIEF DESCRIPTION OF THE DRAWINGS

FIG. 1 is a perspective view of a portable heated storage box according to a preferred embodiment of this invention.

FIG. 2 is a cross-sectional view of the storage box of FIG. 1, taken just inside its front sidewall.

FIG. 3 is a top view of a metal screen housed in the storage box of FIG. 1.

FIG. 4 is a top view of a tray housed in the storage box of FIG. 1.

### DESCRIPTION OF THE PREFERRED EMBODIMENT

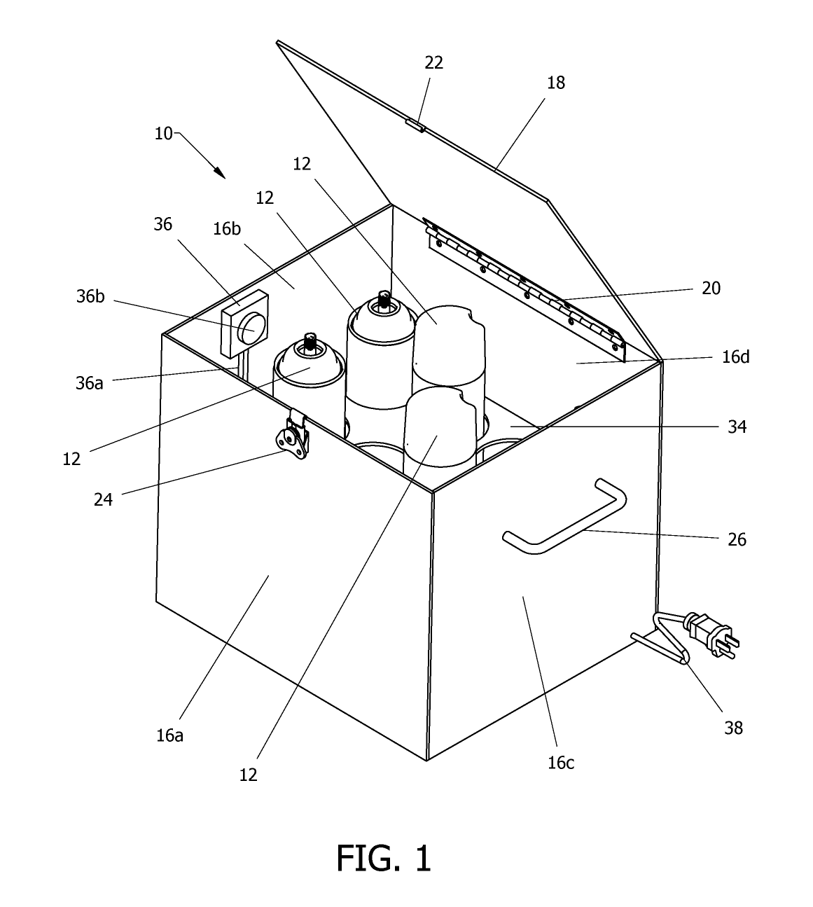

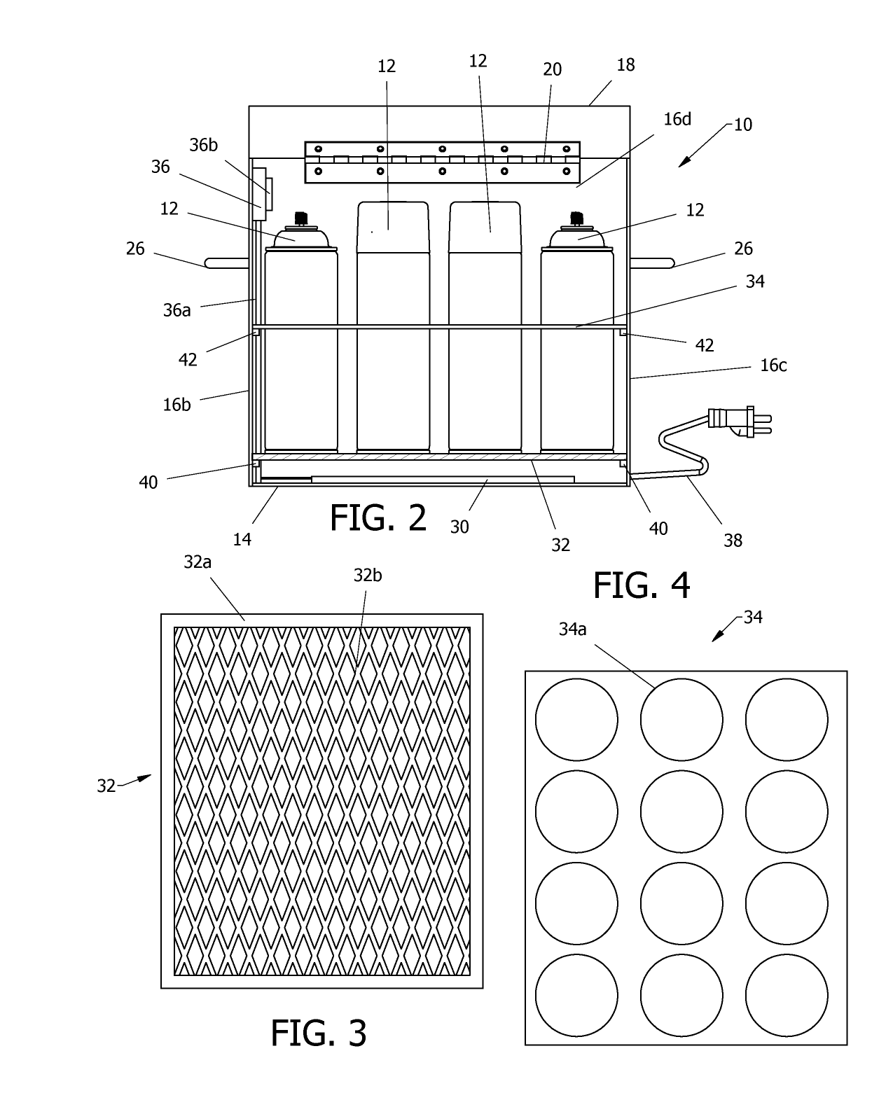

Referring FIGS. 1-2, the reference numeral 10 generally designates a portable heated storage box according to a preferred embodiment of this invention. As illustrated, the storage box 10 is closed to define an interior volume that is configured to hold a number of spray grooming containers 12 in an upright and spaced arrangement. In the illustrated embodiment, the storage box 10 is configured to hold as many as twelve spray containers.

The shell of storage box 10, including a bottom panel 14, sidewalls 16a-16d and a cover 18, are preferably constructed of a durable and lightweight material such as aluminum. The cover 18 is fastened to the rear sidewall 16d by a full-length piano hinge 20 to permit user access to the interior volume of the box 10. A small keeper 22 mounted on the frontal periphery of cover 18 cooperates with a draw latch 24 mounted on the front sidewall 16a to selectively and securely fasten the cover 18 in the closed position. Two handles 26 are mounted on the exterior peripheries of the lateral sidewalls 16b and 16c for ease of lifting and transporting the storage box 10, and a third handle may optionally be mounted on the cover 18. Preferably, the bottom panel 14, cover 18 and sidewalls 16a-16d of storage box 10 are insulated, for example, with a suitable insulating material or coating applied to the interior surfaces thereof.

As best seen in FIG. 2, the interior volume of storage box 10 houses several components, including a waterproof electric heating element 30, a planar metal screen 32, a planar tray 34, and a thermostat 36. By way of example, if the height of the sidewalls 16a-16d is 12.5 inches, the screen 32 may be disposed approximately 1 inch above the bottom panel 14, and the tray 34 may be disposed approximately 5 inches above the screen 32.

The heating element 30 is planar in form factor, is affixed (by high temperature adhesive, for example) to the interior surface of the bottom panel 14, and is powered by standard AC line voltage via an AC line cord 38 that passes through a sealed opening in sidewall 16c. By way of example, the heating element 30 may be an etched foil element encased in silicone rubber to provide the desired moisture and chemical resistance, should the stored spray containers 12 leak.

The metal screen 32 is disposed above the heating element 30, and is supported on a lower ledge 40 formed on the inner peripheries of sidewalls 16a-16d. As illustrated in FIG. 3, the screen 32 includes a marginal aluminum frame 32a that rests on the lower edge 40, and an open-weave screen element 32b within the frame 32a and supported by the frame 32a. The bottom surface of each stored spray container 12 rests on the open-weave screen element 32b, which vertically supports the combined weight of the stored containers 12. In addition to supporting the weight of the spray containers 12, the open-weave of screen element 32b allows the heating element 30 to heat the stored spray containers 12 by both radiation and convection.

The tray 34 is constructed of aluminum or a suitable plastic material, and is disposed above the screen 32, as best seen in FIG. 2. The tray 34 includes a marginal portion supported on an upper ledge 42 formed on the inner peripheries of sidewalls 16a-16d above the lower ledge 40, and a central portion within the peripheral portion. As best seen in FIG. 4, the central portion of the tray 34 is provided with an array of circular openings 34a sized to accommodate the nominal diameter of the spray containers 12. The stored spray containers 12 each pass through a respective tray opening 34a and rest on the screen 32. While the screen 32 vertically supports the stored containers 12, the tray openings 34a laterally engage the stored containers 12 to laterally retain and space them. This ensures even heating of the spray containers 12 by the heating element 30, and protects them from damage during transport. Additionally, the container spacing provided by the tray openings 34a allows the groomer to easily find the product he or she is looking for, without having to rummage around and remove containers in the way of the product being sought.

Finally, the thermostat 36 is mounted on the interior face of sidewall 16b, just above the tray 34, and is coupled to the heating element 30 by the small cable 36a. The thermostat 36 is responsive to the air temperature in the storage box 10, and regulates the operation of heating element 30 to maintain the air temperature within a prescribed range; the prescribed range may be factory set, or user adjustable via the knob (or lever) 36b. For example, the thermostat 36 may be configured to maintain the stored spray containers 12 at a temperature of 70-80 degrees F.

It has been assumed with above-described embodiment of this invention that the storage box 10 would be used as a stand-alone device, but in some instances it may be desirable to install the storage box 10 in a portable cabinet such as a show box that also holds other items used in grooming and showing livestock. There are various ways in which the storage box 10 can be installed in such application; for example, it can be fixed to a shelf in the show box, or can be mounted on a slide rail so that it slides out for access to the stored spray containers 12. With the slide rail installation, the storage box 10 may be configured substantially as shown in the drawings, except that it may be desirable to route the AC line cord 38 through the front sidewall 16a instead of the lateral or back sidewalls 16b-16d. With certain fixed installations, the storage box 10 may be configured substantially as shown, while with other fixed installations, it may be desirable to configure the storage box 10 for front access in the manner of an upright refrigerator. To configure the storage box 10 for front access, the sidewall 16a will serve as the cover, and the tray 34 will be oriented vertically to support the stored spray containers 12 in a horizontal orientation, as opposed to the depicted vertical orientation; in this case, the depicted planar screen 32 will be replaced with wire cages fastened to the inboard face of the tray 34.

It will thus be evident that the portable heated storage box of this invention fulfills a need in the animal husbandry and showmanship world for safely storing grooming product spray containers and maintaining them within an optimal temperature range in cold ambient temperature environments. The bottom heating element, screen, and tray cooperate to hold the containers upright and separate so that they are evenly heated, unlikely to leak, and protected from damage due to rattling around loose during transport. Of course, it is possible to use the storage box of this invention for storing other tubular articles such as grease or caulk cartridges, with similar benefits and advantages.

While the present invention has been described with respect to the illustrated embodiment, it is recognized that numerous modifications and variations in addition to those mentioned herein will occur to those skilled in the art. For example, the storage box may be configured to hold a different number of spray containers than depicted, the heating element 30 may be designed to be powered by a DC source such as a battery, and so on. Accordingly, it is intended that the invention not be limited to the disclosed embodiment, but that it have the full scope permitted by the language of the following claims.

1. A portable heated storage box for storing tubular containers, including spray containers, comprising:
a closed box having a hinged lid to permit user access to an interior volume of the box;
an electric heating element disposed in the interior volume of the box and supported on a bottom panel of the box;
a metal screen disposed in the interior volume of the box above said heating element for supporting the stored tubular containers while allowing the heating element to heat the tubular containers by radiation and convection;
a tray disposed in the interior volume of the box above said metal screen that laterally engages and spaces the stored tubular containers; and
a thermostat that regulates the operation of said heating element to maintain an air temperature in said interior volume within a prescribed range of temperatures.

2. The portable heated storage box of claim 1, where said heating element has a planar form factor, and is affixed to said bottom panel.

3. The portable heated storage box of claim 2, where said heating element comprises an etched foil element encased in silicone rubber to provide moisture and chemical resistance.

4. The portable heated storage box of claim 1, where:
said box includes a first peripheral ledge above said heating element;
said screen includes a marginal metal frame supported on said first peripheral ledge, and an open-weave screen element within said marginal metal frame; and
said stored tubular containers are vertically supported on said open-weave screen element.

5. The portable heated storage box of claim 1, where:
said box includes a second peripheral ledge above said first peripheral ledge;
said tray includes a marginal portion supported on said second peripheral ledge, and central portion within said marginal portion having an array of circular openings sized to accommodate a nominal diameter of the stored tubular containers; and
the stored tubular containers each pass through a respective one of said circular openings so that said tray laterally retains and spaces the stored spray containers.

6. The portable heated storage box of claim 1, where said stored tubular containers are grooming spray containers.
